(19) United States
(12) Patent Application Publication
(10) Pub. No.: US 2007/0119690 A1
(43) Pub. Date: May 31, 2007

(54) ARTICLE ACCUMULATION METHOD AND APPARATUS

(75) Inventor: Clinton R. Lupton, Caledonia, MI (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(73) Assignee: DEMATIC CORP., Grand Rapids, MI (US)

(21) Appl. No.: 11/559,031

(22) Filed: Nov. 13, 2006

Related U.S. Application Data
(60) Provisional application No. 60/597,178, filed on Nov. 15, 2005.

(51) Int. Cl. B65G 13/06

(52) U.S. Cl. 198/781.06

(57) ABSTRACT

A method and apparatus for accumulating articles includes providing a conveying surface adapted to convey articles from an upstream direction towards the downstream direction. The conveying surface is divided into a plurality of tandem zones. Individual zones are activated to convey articles and deactivated to accumulate articles. A particular zone is actuated if no article is sensed in that particular zone and an article is sensed in an adjacent upstream zone. The particular zone and adjacent upstream zone are actuated sufficiently to position a first article at an upstream portion of the particular zone and re-actuated in response to sensing a second article at the adjacent upstream zone and deactuated with the first and second articles in the particular zone.

### CROSS REFERENCE TO RELATED APPLICATION

This application claims priority from U.S. provisional patent application Ser. No. 60/597,178, filed on Nov. 15, 2005, the disclosure of which is hereby incorporated herein by reference in its entirety.

### BACKGROUND OF THE INVENTION

The present invention is directed to a method and apparatus for accumulating articles in a conveying system and, in particular, to a technique for accumulating articles that increases article throughput while minimizing line pressure in accumulated articles. The invention is particularly adapted for use with an accumulation system made up of a conveying surface that is adapted to convey articles for an upstream direction towards a downstream direction and which is divided into a plurality of tandem zones. Each of the zones is actuated to convey articles and deactuated to accumulate articles. A sensor, that may be a contact sensor that is engaged by an article or a non-contact sensor that is not engaged by the articles, senses articles in the zones and actuates the zones as a function of the presence of articles in the zones.

In accumulating conveyor systems, the conveyor's primary purpose is to transport articles but includes an accumulation function when the flow of articles exceeds the ability of the downstream process to handle the articles or downstream the flow is stopped altogether. Various control techniques have been provided for such an accumulation function. However, they have various limitations. One particular accumulation technique controls each zone as a function of the presence or absence of an article in the adjacent downstream zone. Ladder diagram 25 of a prior art singulating type single sensor control technique is illustrated in FIG. 2. In such a prior control technique, an actuator, such as a clutch 20, or motorized roller or pneumatic actuator, is operated if an article sensor from an adjacent downstream zone 16d does not sense an article. Thus, a particular zone is actuated if there is room in the adjacent downstream zone for that article. As is conventional, a slug signal 26 may be provided to more than one zone in order to clear out the articles from the zones in a slug fashion without unnecessary introduction of additional gaps between the articles.

This technique, known as “single-sensor control,” is primarily used with pneumatically actuated roller accumulators in which the conveying surface is freely rotating when in the deactuated state thereby allowing articles to drift into a deactuated zone. The difficulty with a single sensor control technique is that it tends to cause singulation between articles because, during accumulation, each time an article passes a sensor, it momentarily deactuates the adjacent upstream zone. This introduction of gaps between articles can significantly reduce the throughput of the system.

In another prior art control technique 27, article sensors for a particular zone and a downstream zone are used to control the actuation of that particular zone. In this technique, known as a “double article sensor control technique,” an actuator 20 for a particular zone is actuated if an article sensor 16d for the adjacent downstream zone does not sense the presence of an article or if the article sensor 16p of the particular zone being controlled, also known as “current zone,” does not sense the presence of an article (FIG. 3). Thus, if an article is not present in either a particular zone or its next downstream zone, the particular zone is run. As with control technique 25, a slug signal 26 may also be used to operate a particular zone irrespective of the state of article sensors 16d, 16p. This technique is traditionally utilized with an accumulation apparatus that is directly driven by an electric motor, such as a powered roller, or the like. In such an apparatus, the articles are typically unable to drift into a deactuated zone. While such a control technique does not singulate articles to the same extent as a single sensor control scheme, it only accumulates one article in the front of each zone with gaps between articles. When the accumulated articles are discharged, the gaps between the articles reduce throughput of the system.

In another prior art control technique 29, which is known as a look-ahead technique, a zone is run if a downstream sensor 16d does not sense the presence of an article, or if the actuation device 28 of the downstream zone is operating (FIG. 4). Actuation device 28 may be a pneumatic actuator, a clutch, a motorized roller driven unit, or the like. Thus, if there is any downstream zone that is running, a signal will be passed upstream through the zones in order to ensure that all upstream zones are also running. As with other systems, a slug signal 26 may be provided to actuate some or all of the zones to discharge articles without excessive singulation of the articles. While a look-ahead control technique may increase article throughput, it also has the potential for causing the accumulated articles to assert pressure against downstream articles. This phenomenon, known as “line pressure,” can occasionally cause an article to push a downstream article out of line causing side-by-side articles. Side-by-side articles can be detrimental to operation of a conveyor system process, such as article sortation. Certain non-look-ahead zones may be inserted every so often in order to reduce the potential for difficulties arising from excessive line pressure.

### SUMMARY OF THE PRESENT INVENTION

The present invention is directed to an accumulation method and apparatus that overcomes many of the drawbacks of known accumulation control techniques. In particular, the present invention is capable of increasing system throughput by reducing gaps between articles in a manner that does not result in excessive article line pressure. Moreover, the present invention facilitates accumulation at significantly higher conveying speeds than known systems, thereby further increasing article throughput.

A method and apparatus for accumulating articles, according to an aspect of the invention, includes providing a conveying surface adapted to convey articles from an upstream direction towards a downstream direction. The conveying surface is divided into a plurality of tandem zones. Individual zones are actuated to convey articles and deactuated to accumulate articles. Article sensors are provided to sense articles in the zones and the zones are actuated as a function of the sensing of articles in the zones. The actuating of a zone includes actuating a particular zone if no article is sensed in that particular zone and an article is sensed in an adjacent upstream zone. Thus, as an article is passed from an adjacent upstream zone to a particular zone, the particular zone is actuated sufficiently to allow the article to be deposited at an upstream portion of that zone. The zone is, once again, actuated when a following article is sensed in the adjacent upstream zone which causes the particular zone to be actuated until the article previously deposited at an upstream portion of that zone is sensed in that zone, such as at a downstream portion thereof. This provides for placement of more than one article in a zone and a minimizing of gaps between articles while concurrently reducing line pressure between articles.

A method and apparatus of accumulating articles, according to another aspect of the invention, includes providing a conveying surface adapted to convey articles from an upstream direction towards a downstream direction. The conveying surface is divided into a plurality of tandem zones. Individual zones are actuated to convey articles and deactuated to accumulate articles. Articles are sensed in the zones, such as by an article sensor, and the zones are actuated as a function of articles sensed. The zones are actuated by momentarily actuating a particular zone and its adjacent upstream zone sufficiently to position a first article at an upstream portion of that particular zone. That particular zone is re-actuated in response to a sensing of a second article at an adjacent upstream zone and deactuated with the first and second articles in the particular zone.;

In any of the techniques set forth above, the particular zone may also be actuated if no article is sensed in an adjacent downstream zone. Alternatively, in any of the techniques set forth above, a particular zone may be actuated if an adjacent downstream zone is actuated. This allows articles accumulating in a particular zone to be moved forward until a slug of articles is further formed. As with conventional accumulation techniques, a slug discharge function may be provided in order to clear out an entire accumulation line without singulation.

These and other objects, advantages and features of this invention will become apparent upon review of the following specification in conjunction with the drawings.

### BRIEF DESCRIPTION OF THE DRAWINGS

FIG. 1 is a top plan view of an accumulation apparatus that is useful with the present invention;

FIG. 2 is a control ladder diagram of a prior art accumulation control technique;

FIG. 3 is a control ladder diagram of another prior art accumulation control technique;

FIG. 4 is a control ladder diagram of yet another prior art accumulation control technique;

FIG. 5 is a control ladder diagram of an accumulation control method, according to the invention;

FIG. 6 is a control ladder diagram of an accumulation control method, according to an alternative embodiment of the invention;

FIG. 7 is a control ladder diagram of another alternative embodiment of the invention;

FIGS. 8a-8h are diagrams illustrating accumulation of articles, according to the invention; and

FIG. 9 is a control ladder diagram of another alternative embodiment of the invention.

### DESCRIPTION OF THE PREFERRED EMBODIMENT

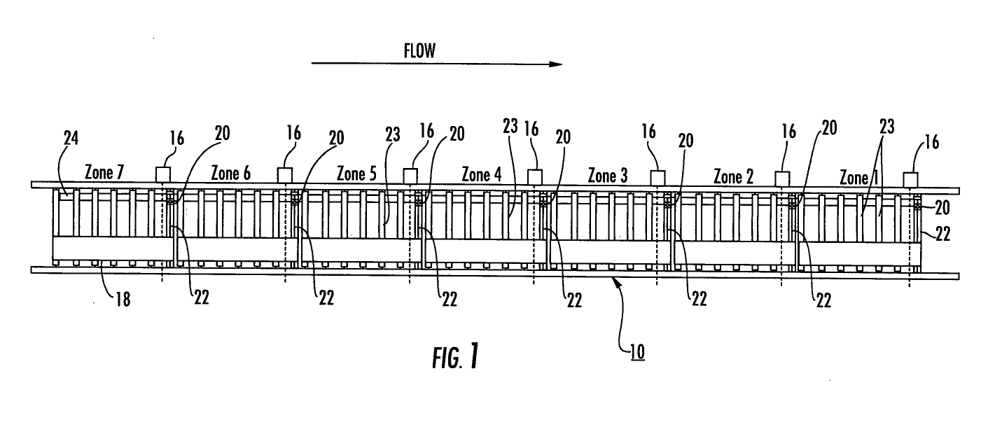

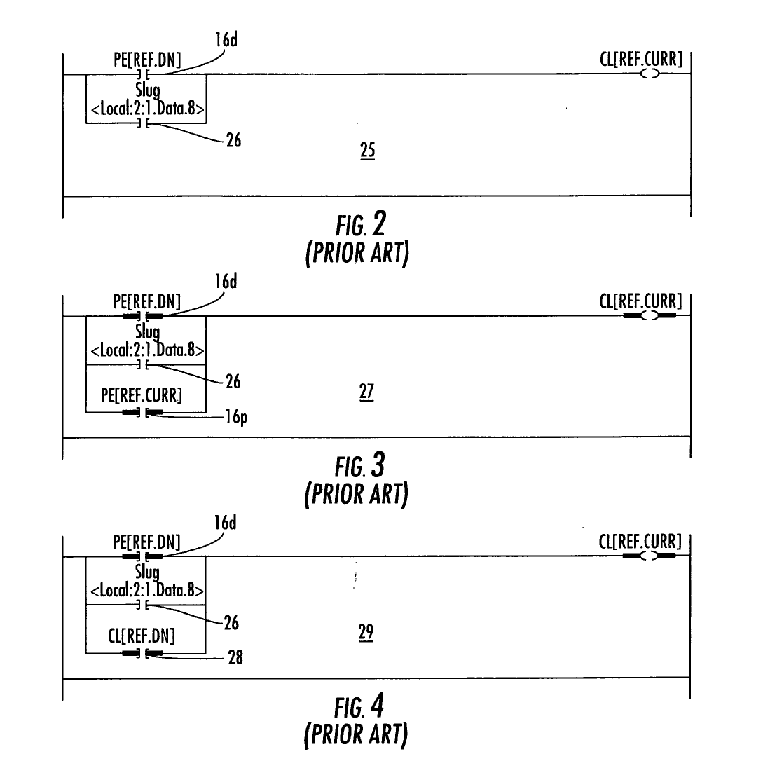

Referring now specifically to the drawings, and the illustrative embodiments depicted therein, the invention is illustrated for use with an accumulation conveyor assembly 10, including a conveying surface defined by a series of conveying belts 18, each of which defines an accumulation zone depicted as zones 1-7 (FIG. 1). It should be understood that accumulation conveyor assembly 10 may be part of a much longer accumulation assembly and typically feeds a downstream process, such as a sortation assembly, a loading dock, or the like. In the illustrative embodiment, articles flow from left-to-right, as viewed in FIG. 1, from upstream zone 7 to downstream zone 1 and beyond. In the illustrative embodiment, accumulation conveyor assembly 10 includes a series of rollers including drive rollers 22 and belt support rollers 23. Drive roller 22 includes a clutch portion 20 having an electromagnetic clutch. Clutch portion 20 is in contact with drive belt 24 such that when drive belt 24 is moving, which is usually the situation in the illustrated embodiment, clutch portion 20 is rotating. When the electromagnetic clutch 20 is actuated by a control (not shown), the movement of drive belt 24 is transmitted to conveying belt 18. When the electromagnetic clutch 20 is deactuated, the motion of belt 24 is not transmitted to conveying belt 18 and the zone does not run. However, the construction allows the conveying belt 18 to be moveable when the zone is deactuated such that an article can drift into a zone if propelled therein from an upstream zone. Also, a deactuated zone tends to coast to a stop, rather than abruptly stopping, especially when the belt is loaded with an article.

The invention is illustrated with an accumulation conveyor assembly of the type illustrated in commonly assigned U.S. patent application Ser. No. 60/684,378, filed on May 25, 2005, entitled AIRLESS ACCUMULATION CONVEYOR, by Stephen C. Wolf and U.S. patent application Ser. No. 60/714,931, filed on Sep. 7, 2005, entitled AIRLESS ACCUMULATION CONVEYOR, by Harry Thad German, the disclosures of which are hereby incorporated herein by reference in their entireties. Each zone further includes an article sensor 16. In the illustrative embodiment, article sensor 16 is a non-contact article sensor, such as a photo-eye. However, various other types of sensors, such as article-contacting article sensors, such as sensing rollers, and the like, may also be used. In the illustrative embodiment, article sensor 16 is located at a downstream portion of the particular associated zone. Article sensor 16 may be located at the transition from one zone to another or may be located upstream of the transition. Moreover, although the invention is illustrated in the context of particular hardware, it should be understood that the invention may be applied with other types of hardware as well. In particular, although the invention is illustrated with conveying belts for a conveying surface, it could also be used with roller-type conveying surfaces. Also, other forms of drive may be utilized, such as electric motor drive, such as motorized rollers. The zones may be actuated by other techniques, such as pneumatic actuation. The electronic control 10 may be of various architectures. For example, the control may be a bed controller associated with a plurality of accumulation zones, and in communication with other bed controllers. Alternatively, individual controllers may be provided for each zone and in communication with the controllers for adjacent zones.

In a control method 30, according to an embodiment of the invention, clutch 20 for a particular zone is actuated in order to actuate that zone based upon the condition of articles in a particular zone as sensed by an article sensor 16p for the present zone, and articles in an adjacent upstream zone as sensed by an article sensor 16u for the upstream zone. In particular, clutch 20 is actuated in order to actuate a particular zone if sensor 16p in the particular zone does not sense the presence of an article and sensor 16u in the adjacent upstream zone does sense the presence of an article. Additionally, an independent basis for operating clutch 20 may be provided by the condition of the adjacent downstream zone not sensing an article, as sensed, for example, by downstream article sensor 16d. Therefore, clutch 20 for a particular zone is actuated to actuate that zone if the downstream article sensor 16d does not sense the presence of an article in the adjacent downstream zone. As with other disclosed control techniques, a slug signal 26 may be provided in order to actuate some or all of the zones in order to clear out accumulated articles without introducing excessive gaps between the articles.

Thus, in control technique 30, if article sensor 16p for a particular zone does not sense the presence of an article, the zone will be actuated when an article is present in the adjacent upstream zone as detected by upstream article sensor 16u. Because, in the illustrative embodiment, the article sensors are located at a downstream portion of each zone or at the transition from one zone to another, the upstream article sensor 16u will be actuated in order to actuate clutch 20 when an article reaches the downstream end of the upstream zone. Thus, the article is transferred to the upstream zone to the downstream zone. As soon as at the trailing edge of the article clears the article sensor 16u, the particular zone will be deactuated. In the illustrated embodiment, each zone coasts to a stop when deactuated, particularly, when an article, such as an article incoming from an upstream zone, is on the belt 18 for that zone. This will result in the article being deposited on an upstream portion of the particular zone. When the next article is detected in the upstream zone by upstream zone article sensor 16u, the particular zone is, again, actuated until the article already present in that zone reaches article sensor 16p and is thereby detected. This allows a second (and even potentially a third, fourth, or more) article to be positioned entirely, or at least partially, in the particular zone. Thus, it is seen that more than one article can be positioned in a zone because an article is not necessarily transmitted all the way up to the downstream end of a zone in order to deactuate that zone.

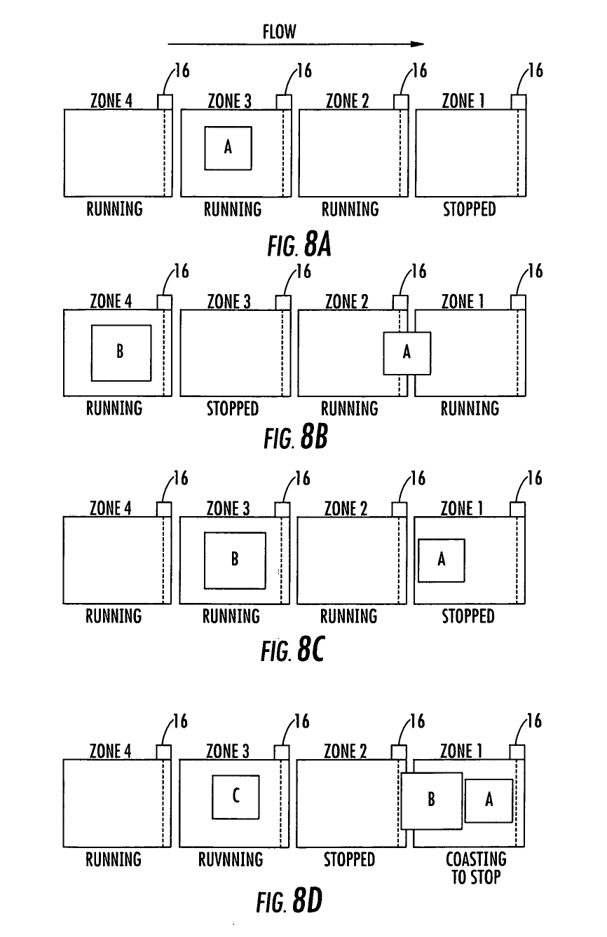

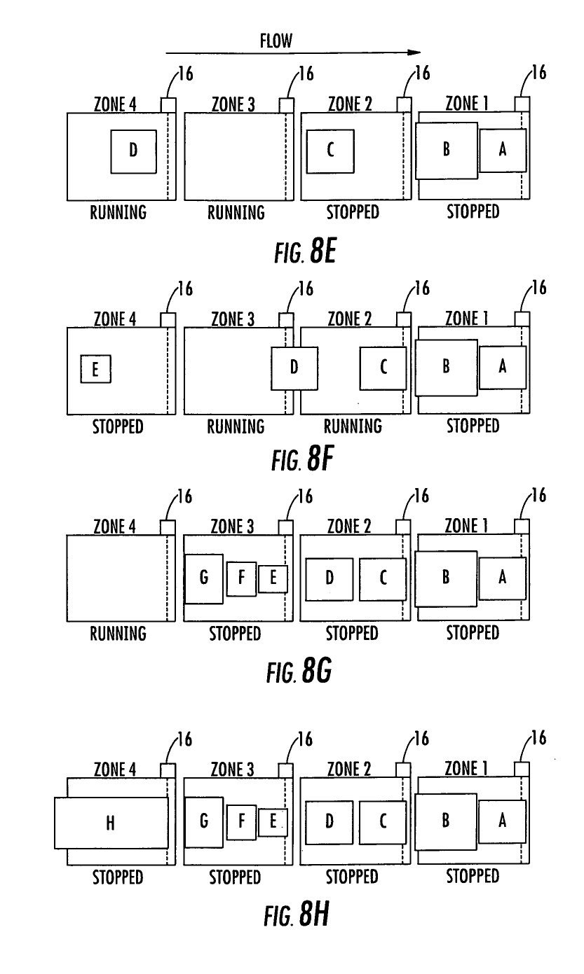

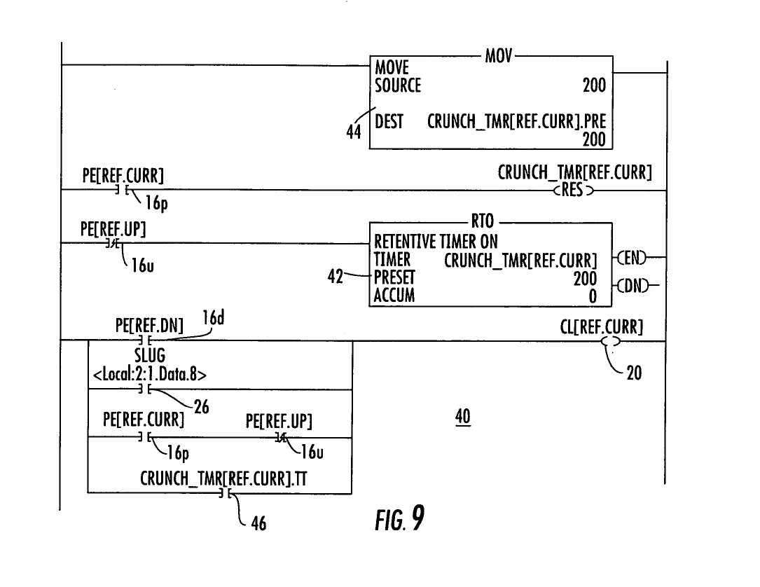

Operation of accumulation conveyor system 10 can best be illustrated with respect to FIGS. 8a-8h. While the invention is illustrated with articles that are rectangular boxes, it should be understood that the invention may be adapted to accumulating a wide range of articles of various textures, densities, sizes and shapes. When the system 10 is empty, zone 1, which is the most downstream zone, is stopped or deactuated, and the remaining zones are running or actuated. Zone 1 is stopped because sensor 16u from zone 2 is, not sensing an article and a signal from a downstream process, which would correspond with downstream sensor 16d, would be instructing zone 1 to not run. At some point when it is desired to discharge accumulated articles, that same signal from the downstream process would actuate zone 1 either by simulating a condition where the downstream sensor 16d is not sensing an article or by actuating the slug signal 26. With no articles on the accumulator, zones 2 and above are running because their respective sensors 16d of adjacent downstream zones are not sensing articles.

When an article A enters the accumulator, it is passed down to zone 2 because of the running zones. When article A breaks the photo-eye 16 of zone 2, zone 1 begins to run because the sensor for zone 1 of sensor 16p does not sense an article and the sensor 16u of the adjacent upstream zone does sense an article. Thus, article A is transferred to zone 1. As soon as the trailing edge of article A clears photo-eye 16 of zone 2, zone 1 becomes deactuated. Although this occurs as soon as article A clears photo-eye 16 of zone 2, article A does not abruptly stop in the illustrated embodiment, but, rather, coasts to a stop over a period of time as a result of the freewheeling nature of deactuated zones. In the illustrative embodiment, photo sensors 16 are located a number of inches back from the transition to the next zone. With a suitable selection of parameters, article A will come to rest at an upstream end of zone 1 and zone 1 will be- stopped, as illustrated in FIG. 8c.

The next article B on the accumulator travels to the downstream end of zone 2 and breaks the beam of photo-eye 16. This causes zone 1 to momentarily run because the photo-eye 16p of zone 1 is not sensing an article, and zone 16u of zone 2 is sensing an article. Thus, zone 1 will run until either article A breaks the beam of photo-eye 16 of zone 1 or the trailing edge of article B clears the beam of photo-eye 16, as illustrated in FIG. 8d, thereby deactuating zone 1 and allowing articles A and B to coast to a stop, both in zone 1.

With the photo-eye 16 of zone 1 blocked and with the photo-eye of zone 2 unblocked, zone 2 will stop running. The next article C traveling along the accumulator will block the photo-eye 16 of zone 3 which will cause zone 2 to momentarily be actuated causing article C to coast to a stop at the upstream and of zone 2, as illustrated in FIG. 8e. When the next article D breaks the photo-eye 16 of zone 3, zone 2 begins to run because its article sensor 16d does not sense an article and the upstream photo-sensor 16u for zone 3 does sense an article. Zone 2 will continue to run until either article C breaks the beam of photo-eye 16 or the photo-eye 16 of zone 3 clears the trailing edge of article D. Articles C and D are then accumulated in zone 2, which is stopped as illustrated in FIG. 8g. Once article D is transferred from zone 3 to zone 2, zone 4 stops the next article E at its upstream end because its downstream photo sensor 16d is blocked by article D and its upstream photo sensor 16u does not sense an article. However, when article D clears photo-eye 16 of zone 3, zone 4 will be actuated and article E will pass to zone 3. The subsequent articles F and G will be accumulated in zone 3 in a similar manner to that previously described. If a large article H is positioned on system 10, article H will travel down to the next open zone 4 and will accumulate on zone 4 and, if necessary, extend to the previous upstream zone (not shown).

The accumulation method 30 facilitates the accumulation of multiple articles on each zone. Thus, when the zones are discharged, such as by actuation of slug signal 26 or by a discharge signal sent to zone 1, the articles are closely spaced, thereby facilitating high throughput to the system. Moreover, the articles are accumulated in this fashion with little or no line pressure to the articles. Any contact between articles should be a momentary bumping between articles which should not tend to knock articles out of single file orientation. Also, accumulation method 30 provides a stopped zone which acts as a buffer between incoming articles and articles that are already accumulated in a slug. While the stopped zone may have one or more articles accumulated in it, there should be a gap between such articles and the downstream accumulated articles. This buffer zone allows the accumulation hardware to be run at a higher line speed. Indeed, in the illustrative embodiment, the conveying surface defined by conveying belts 18 may be operable at speeds of at least 300 feet per minute and greater. Indeed, the conveying surface may be operated at speeds of at least 600 feet per minute.

Thus, the present invention provides an accumulation function which increases throughput without unduly increasing line pressure of accumulated articles. This is accomplished by accumulating articles in slugs, but without upstream articles putting pressure on the entire line of downstream accumulated articles. Moreover, the articles are accumulated in a fashion that allows for the hardware to be operated at speeds that are higher than previously obtainable with conventional accumulation techniques. This combination of conveying articles in slugs with minimum gap between the articles and at greater line speeds results in a potentially significant increased throughput than previously possible.

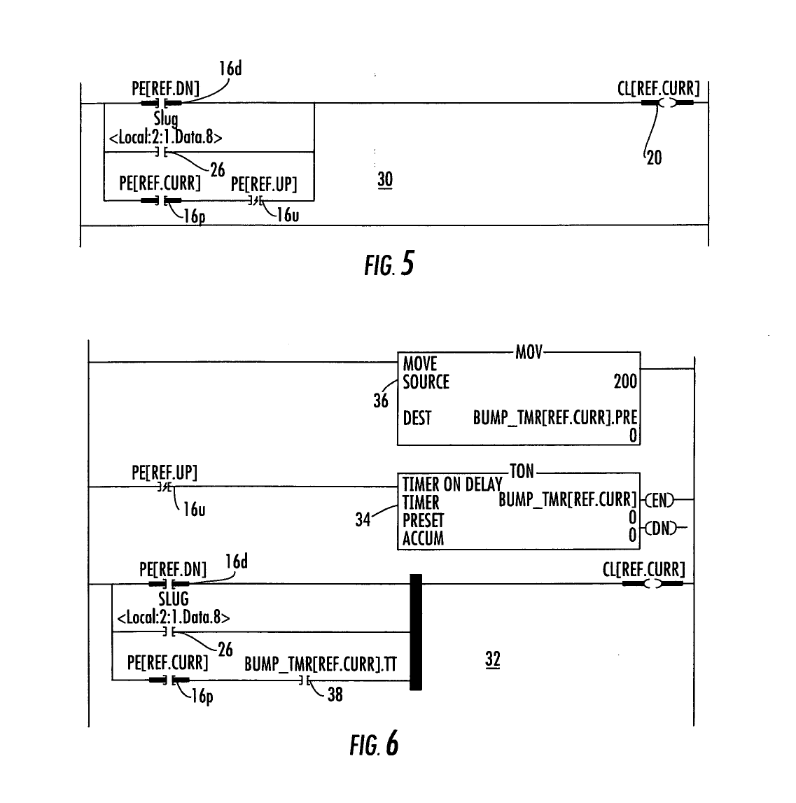

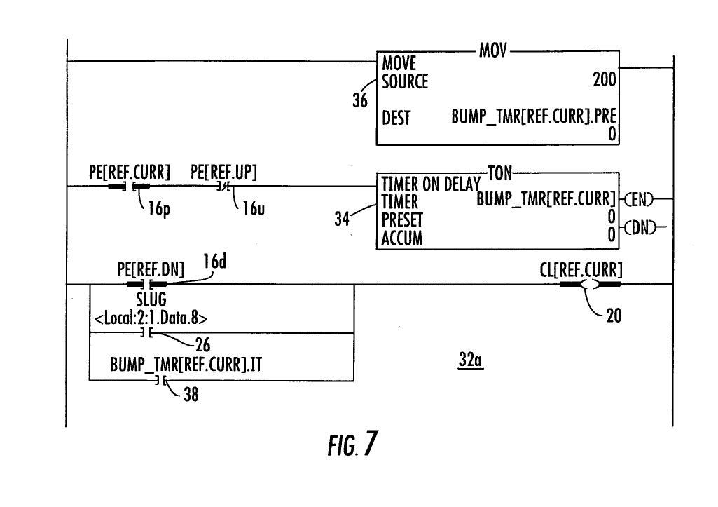

In the illustrated embodiment, photo sensor 16 is a number of inches upstream of the transition between zones. This allows an article to coast to a stopped position on a zone in the distance from the point where the trailing edge of the package clears the upstream photo-eye until the package comes to a rest in its zone. However, it may be desirable to position the photo-eye at the transition between zones. In order to avoid the article from coming to rest too far downstream in the zone, an accumulation method with leading edge pulse timer 32 may be provided (FIG. 6). In method 32, a leading edge timer 34 is provided. Leading edge timer 34 is loaded with a particular time, which, in the illustrative embodiment, is 200 milliseconds at 36. Timer 34 is operated when the upstream article sensor 16u is initially broken by the leading edge of an article. The output of 38 of timer 34 is placed in series with the article sensor 16p, of the present zone. The remaining portions remain the same as method 30.

Thus, in operation, when the leading edge of an article blocks the beam of the upstream photo sensor 16u, timer 34 begins to timeout. While timer 34 is timing, its output 38 is made. If the article sensor of the present sensor 16p does not sense an article, clutch 20 is actuated for the particular zone. At the end of the preset time period for timer 34, as set at 36, the timer will timeout and output 38 will open resulting in clutch 20 of the particular zone being deactuated. This allows the particular zone to become deactuated even before the trailing edge of the article coming into the zone clears the upstream photo-eye. Thus, as the article coasts to a rest on the particular zone, the trailing edge should more closely align with the upstream edge of the particular zone. This facilitates the placement of the photo-eye at the transition of the zones without resulting in the positioning of articles further downstream in a particular zone. If a small article blocks the beam of the upstream photo sensor 16u for a time that is less than the time set for timer 34, timer 34 will be reset and its output 38 opened, thus allowing clutch 20 to be deactuated as soon as the article clears the upstream photo sensor without the necessity for waiting for the timer to timeout.

An accumulation control method 32a is similar to method 32. However, timer 34 is run when both the particular zone sensor 16p does not sense articles and the upstream zone sensor 16 does not sense articles. The output 38 of timer 34 runs the particular zone when true. Method 32a will run the particular zone should a package be manually removed or the consolidation function, described in detail below, is performed. Otherwise, operation is the same as with method 32.

In yet an additional embodiment, an accumulation method 40 having slug compression utilizes a compression timer 42 whose time period is set at 44 (FIG. 9). In the illustrative embodiment, timer 42 may be set to 200 milliseconds. The output 46 of timer 42 is placed in parallel with the remaining conditions for actuating clutch 20, thus providing an independent actuation of the clutch as will be described below. Timer 42 is set when the article sensor of the adjacent upstream zone 16u senses an article and is reset when the article sensor of the present zone 16p does not sense an article. In operation, when the article sensor of the present zone 16p does not sense an article, timer 42 is reset and cannot run. When photo sensor 16u of the adjacent upstream zone is blocked, timer 42 will begin timing provided that the article sensor of the particular zone is not blocked. This causes clutch 20 to be actuated for a period of time after the downstream article in the zone blocks its article sensor beam. This allows the article to be driven further into the next zone, thereby potentially contacting the articles in the downstream zone. This has the advantage of additionally removing gaps between articles thereby providing slug compression. Slug compression is especially useful for an article mix that is not likely to be susceptible to line pressure difficulties.

In yet an additional embodiment, an article consolidation function is provided. An article consolidation function, which may utilize the slug signal 26, applies a momentary drive signal to all of the clutches 20. This signal, which may be, for example, from 200 to 250 milliseconds, is insufficient to appreciably move any back-to-back articles. However, in situations where gaps exist between articles, particularly small or lightweight articles, the momentary pulse to clutches 20 may be sufficient to move an article sufficiently to expose an article sensor. When an article sensor is exposed, the upstream zone is driven which may consolidate a slug by further removing gaps between articles. This may, in turn, result in other article sensors being exposed, thus providing a nudging of the articles and a removing of gaps in the slug. However, this should not create appreciable line pressure because it will have minimal effect on back-to-back articles and the closing of gaps is done only until all article sensors are again sensing articles.

While the invention is illustrated with a zone being operated if the article sensor of the adjacent downstream zone 16d is not sensing an article, the invention may also be utilized in combination with a look-ahead accumulation technique. In such a technique, the running condition of the downstream zone would be substituted for the downstream photo-eye or a combination of both. As would be understood by the skilled artisan, corresponding changes in the control algorithm may be required. Also, the use of a sleep timer may be incorporated into the accumulation control method. The use of a sleep timer, which is conventional, would allow the zones to be stopped when there are no articles being fed to the accumulation conveyor assembly 10. The sleep timer may be applied directly to the control methods 30, 32, 32a, 40. Alternatively, the sleep timer may be applied to stopping the movement of drive belt 24.

Changes and modifications in the specifically described embodiments can be carried out without departing from the principles of the invention which is intended to be limited only by the scope of the appended claims, as interpreted according to the principles of patent law including the doctrine of equivalents.

The embodiments of the invention in which an exclusive property or: privilege is claimed are defined as follows:

1. A method of accumulating articles, comprising:
providing a conveying surface adapted to convey articles from an upstream direction toward a downstream direction, said conveying surface divided into a plurality of tandem zones, actuating individual zones to convey articles and deactuating individual zones to accumulate articles;
sensing articles in said zones and actuating said zones as a function of said sensing;
wherein said actuating zones includes actuating a particular zone if no article is sensed in that particular zone and an article is sensed in an adjacent upstream zone.

2. The method of accumulating articles as claimed in claim 1 further including actuating said particular zone if no article is sensed in an adjacent downstream zone.

3. The method of accumulating articles as claimed in claim 1 further including actuating said particular zone if an adjacent downstream zone is actuated.

4. The method of accumulating articles as claimed in claim 1 wherein said actuating zones further includes actuating of a particular zone for a period of time when an article is sensed in said adjacent upstream zone.

5. The method of accumulating articles as claimed in claim 1 wherein said conveying surface is passively moveable in a zone when that zone is deactuated.

6. The method of accumulating articles as claimed in claim 5 including said conveying surface in that particular zone coasting to a stop with an article propelled from said adjacent upstream zone when that particular zone is deactuated.

7. The method of accumulating articles as claimed in claim 5 including deactuating that particular zone with at least a portion of an article in said adjacent upstream zone.

8. The method of accumulating articles as claimed in claim 1 wherein said conveying surface comprises a series of conveyor belts, each of said conveyor belts defining one of said zones.

9. A method of accumulating articles, comprising:
providing a conveying surface adapted to convey articles from an upstream direction toward a downstream direction, said conveying surface divided into a plurality of tandem zones, actuating individual zones to convey articles and deactuating individual zones to accumulate articles;
sensing articles in said zones and actuating said zones as a function of said sensing;
wherein said actuating zones includes momentarily actuating a particular zone and an adjacent upstream zone sufficiently to position a first article at an upstream portion of said particular zone, re-actuating said particular zone in response to sensing a second article at said adjacent upstream zone and deactuating said particular zone with said first and second articles in said particular zone.

10. The method of accumulating articles as claimed in claim 9 including deactuating said particular zone with said first and second articles in said particular zone when the first article is sensed at a downstream portion of said particular zone or the second article has passed a downstream portion of said adjacent upstream zone.

11. The method of accumulating articles as claimed in claim 9 further including actuating said particular zone if no article is sensed in an adjacent downstream zone.

12. The method of accumulating articles as claimed in claim 9 further including actuating said particular zone if an adjacent downstream zone is actuated.

13. The method of accumulating articles as claimed in claim 9 wherein said actuating zones further includes actuation of a particular zone for a period of time when an article is sensed in said adjacent upstream zone.

14. The method of accumulating articles as claimed in claim 9 wherein said conveying surface is passively moveable in a zone when that zone is deactuated.

15. The method of accumulating articles as claimed in claim 14 including said conveying surface in that particular zone coasting to a stop with an article propelled from said adjacent upstream zone when that particular zone is deactuated.

16. The method of accumulating articles as claimed in claim 14 including deactuating that particular zone with at least a portion of an article in said adjacent upstream zone.

17. The method of accumulating articles as claimed in claim 9 wherein said conveying surface comprises a series of conveyor belts, each of said conveyor belts defining one of said zones.

18. A method of accumulating articles, comprising:
providing a conveying surface adapted to convey articles from an upstream direction toward a downstream direction, said conveying surface divided into a plurality of tandem zones, actuating individual zones to convey articles and deactuating individual zones to accumulate articles;
wherein said actuating zones includes deactuating at least one downstream zone with articles accumulated on said at least one downstream zone;
wherein said actuating zones further includes deactuating a buffer zone that is an adjacent upstream zone to said at least one downstream zone; and
wherein said actuating ones further includes momentarily actuating said buffer zone to receive a first article and deactuating said buffer zone with the first article accumulated on said buffer zone.

19. The method of accumulating articles as claimed in claim 18 wherein said actuating zones further includes momentarily actuating said buffer zone to receive a second article and deactuating said buffer zone with the first and second articles accumulated on said buffer zone.

20. The method of accumulating articles as claimed in claim 19 including deactuating said buffer zone with the first and second articles accumulated on said buffer zone when the first article is sensed at a downstream portion of said buffer zone or the second article has passed a downstream portion of a zone that is an adjacent upstream zone to said buffer zone.

21. The method of accumulating articles as claimed in claim 18 wherein said conveying surface comprises a series of conveyor belts, each of said conveyor belts defining one of said zones.

22. The method of accumulating articles as claimed in claim 18 wherein said conveying surface is adapted to convey articles at a speed of at least 300 feet per minute.

23. The method of accumulating articles as claimed in claim 22 wherein said conveying surface is adapted to convey articles at a speed of approximately 600 feet per minute.
